(19) United States
(12) Patent Application Publication
(10) Pub. No.: US 2015/0284286 A1
(43) Pub. Date: Oct. 8, 2015

(54) METHOD FOR MAKING PREFORMS AND OPTICAL FIBERS

(71) Applicant: Corning Incorporated, Corning, NY (US)

(72) Inventors: Ming-Jun Li, Horseheads, NY (US); Xiaoming Luo, Painted Post, NY (US); Joseph Edward McCarthy, Hornell, NY (US); Gaozhu Peng, Horseheads, NY (US); Jeffery Scott Stone, Addison, NY (US); Pushkar Tandon, Painted Post, NY (US); Chunfeng Zhou, Painted Post, NY (US)

(73) Assignee: CORNING INCORPORATED, CORNING, NY (US)

(21) Appl. No.: 14/247,894

(22) Filed: Apr. 8, 2014

(51) Int. Cl. C03B 37/014; C03B 37/027; C03B 37/012; C03B 37/018

(52) U.S. Cl. CPC C03B 37/014; C03B 37/01853; C03B 37/027; C03B 37/01222; C03B 2203/34

(57) ABSTRACT

A method of forming an optical fiber includes the steps of forming a soot blank of a silica-based cladding material, wherein the soot blank has a top surface and a bulk density of between 0.8 g/cm2 and 1.6 g/cm3. At least one hole is drilled in the top surface of the soot blank. At least one core cane member is positioned in the at least one hole. The soot blank and at least one soot core cane member are consolidated to form a consolidated preform. The consolidated preform is drawn into an optical fiber.

### FIELD OF THE INVENTION

The present invention generally relates to a method for making a preform including the step of drilling holes in a soot blank for placement of core canes and a method for forming an optical fiber from such a preform.

### TECHNICAL BACKGROUND

Data transfer is fast approaching ultimate capacity limits for single mode optical fiber transmission systems. The use of multicore optical fibers has emerged as one solution which enables further growth in the capacity of optical fibers. Multicore optical fibers permit parallel transmission using space-division multiplexing. Multicore optical fibers increase transmission capacity by N-fold, where “N” is the number of cores in the multicore optical fiber. Several conventional methods for manufacturing multicore optical fibers are complicated and are not well-suited for large volume production. In a stack and draw process, core glass rods are typically stacked and inserted in a glass tube to form a preform. Such a method is generally complicated and not easily scaled. In another method, holes are drilled in a glass substrate and core canes are placed in the hole. However, it is difficult to drill accurately into a glass rod, and an expensive high precision ultrasonic drilling machine is required. Even with such a drilling machine, the distance that the hole can be drilled is limited, thereby limiting the preform size.

### SUMMARY

According to one embodiment, a method of forming an optical fiber includes the steps of forming a soot blank of a silica-based cladding material, wherein the soot blank has a top surface and a bulk density of between 0.8 g/cm³ and 1.6 g/cm³. At least one hole is drilled in the top surface of the soot blank. At least one core cane member is positioned in the at least one hole. The soot blank and the at least one soot core cane member are consolidated to form a consolidated preform. The consolidated preform is drawn into an optical fiber.

In another embodiment, a method of forming a soot blank includes the steps of forming a soot body using a silica-based soot material. The soot body is partially consolidated to form a soot blank with a top surface and a bulk density of between 0.8 g/cm³ and 1.6 g/cm³. A plurality of holes is drilled into the top surface of the soot blank.

In yet another embodiment, a method of forming a multicore optical fiber includes the steps of forming a soot body of a silica-based material. The soot body is partially consolidated to form a soot blank with a bulk density of between 0.8 g/cm³ and 1.6 g/cm³ and a top surface with a surface density of less than 1.6 g/cm³ and a bottom surface opposite the top surface. A plurality of holes are drilled in the top surface, wherein the holes do not reach the bottom surface. A plurality of core canes are inserted into the plurality of drilled holes. The soot blank and the core canes are consolidated to form a consolidated preform. The consolidated preform is drawn into a multicore optical fiber.

Additional features and advantages will be set forth in the detailed description which follows, and in part will be readily apparent to those skilled in the art from that description or recognized by practicing the embodiments as described herein, including the detailed description which follows, the claims, as well as the appended drawings.

The method disclosed herein is more easily scalable, and results in a more economical and less complicated production process for making preforms and optical fibers, particularly multicore optical fibers, than known methods for production of these preforms and optical fibers.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a process flow chart of one method for forming optical fibers according to the present disclosure;

FIG. 2 is a top perspective view of a soot body according to the present disclosure;

FIG. 3 is a top perspective view of a soot blank with holes drilled therein formed from the soot body of FIG. 2;

FIG. 4 is a top perspective view of the soot blank of FIG. 3 with core canes positioned therein;

FIG. 5 is a top perspective view of another embodiment of a soot body according to the present disclosure;

FIG. 6 is a top perspective view of a soot blank with holes drilled therein formed from the soot body of FIG. 5;

FIG. 7 is a top perspective view of the soot blank of FIG. 6 with core canes and a glass rod positioned therein

FIG. 8 is a top perspective view of a preform according to the present disclosure formed from the soot blank shown in FIG. 7;

FIG. 9 is a top perspective view of an optical fiber drawn from the preform shown in FIG. 8;

FIG. 10A is a top plan view of a soot blank with a square configuration with four drilled holes;

FIG. 10B is a top plan view of a soot blank with a 2×4 configuration with eight drilled holes;

FIG. 10C is a top plan view of a soot blank with a hexagonal lattice configuration with seven drilled holes; and

FIG. 10D is a top plan view of a soot blank with a ring configuration with twelve drilled holes.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

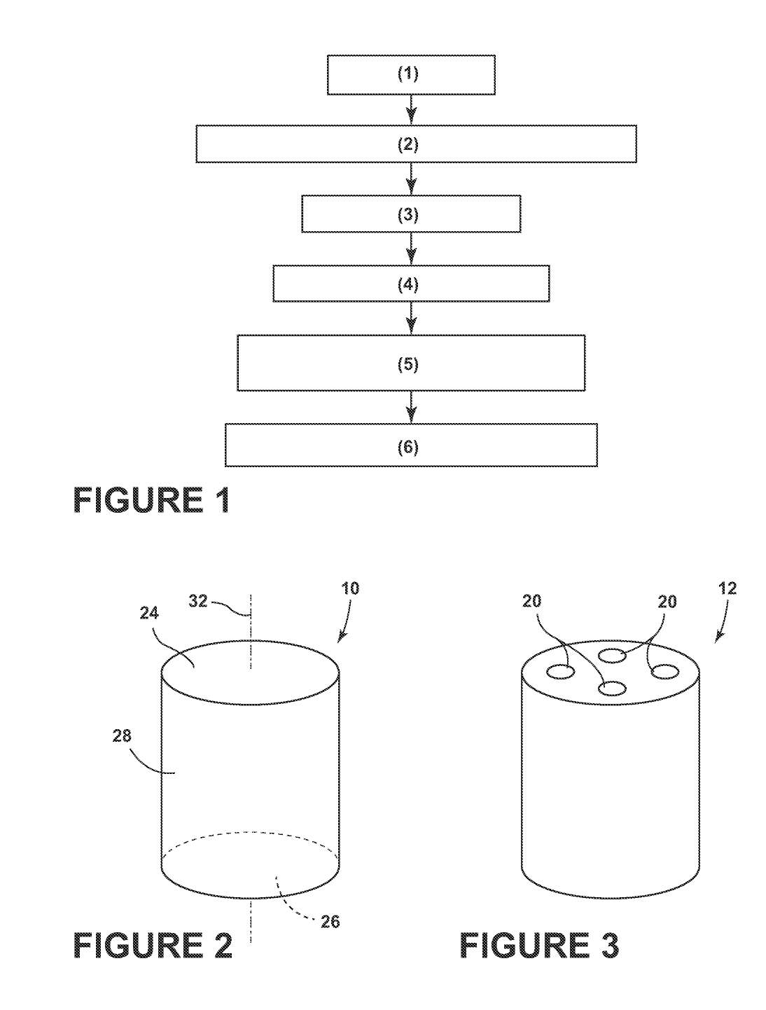

One embodiment of the method for forming preforms and ultimately optical fibers is generally depicted in FIG. 1. FIGS. 2-9 depict the formation of a soot body 10, a soot blank 12, a preform 14, and an optical fiber 16 at various steps throughout the method that is depicted in FIG. 1. In the embodiment depicted in FIG. 1, the method of forming the optical fiber 16 includes the steps of (1) forming the soot body 10 and (2) partially consolidating the soot body 10 to form the soot blank 12. (3) Holes 20 are then drilled in the partially consolidated soot blank 12, and (4) core canes 22 are inserted into the holes 20. (5) The soot blank 12 and the core canes 22 are then consolidated to form the glass preform 14. (6) The glass preform 14 is drawn to form the optical fiber 16. The process as described herein is particularly useful in the formation of multicore optical fibers 16, but can also be used for the preparation of single core optical fibers 16. Multicore optical fibers 16 are desirable to allow parallel transmission through space-division multiplexing. The transmission capacity of the fiber 16 is increased by N-fold, where N is the number of cores in the multicore optical fiber 16. Therefore, multicore optical fibers 16 allow for enhanced transmission with respect to single core optical fibers 16.

FIGS. 2-4 depict an embodiment of a soot body 10 and soot blank 12 formed via a soot pressing method, and FIGS. 5-9 depict an embodiment of a soot body 10 and soot blank 12 formed via an outside vapor deposition (“OVD”) process. The method of drilling the soot blank 12 described herein can be used with either of these formation methods for the soot body 10, as further described below.

As depicted in FIGS. 2 and 5, the soot body 10 is a generally cylindrical shape, with a top surface 24, a bottom surface 26 opposite the top surface 24, and a circumferential wall 28 interconnecting the top surface 24 and the bottom surface 26. The soot body 10 is made of a silica-based material which is appropriate for cladding of optical fibers 16. In one embodiment, the soot body 10 is a SiO₂ material. In alternate embodiments, the SiO₂ material may be doped with elements such as F, B, Ge, Er, Ti, Al, Li, K, Rb, Cs, Cl, Br, Na, Nd, Bi, Sb, Yb, or combinations thereof, or other elements known for use in cladding of optical fibers 16.

The embodiment of a soot body 10 shown in FIG. 2 is formed via a soot pressing process. Generally, in the soot pressing process, particulate soot material is deposited into a mold cavity, and pressure is applied against the particulate soot material in the mold to form a compacted soot body 10. The soot pressing process is usually carried out at pressures of from 25 psig to 250 psig, and the particulate soot material can be radially compressed, axially compressed, laterally compressed, or compressed in any other method to form a compacted soot body 10. Compacted soot bodies 10 formed via soot pressing processes generally have an initial bulk density of 0.8 g/cm³. The compacted soot body 10 is preferably partially consolidated, to reach a preferred bulk density and surface density for drilling, as further described below.

The embodiment of a soot body 10 shown in FIG. 5 is formed via an OVD process. In this process, generally an inert rod is layered with silica-based soot particles applied around the perimeter of the inert rod. The soot particles are formed by passing ultrapure vapors, such as silicon chloride through a burner, where the vapors react in the flame to form fine silica-based soot particles that are then deposited on the inert rod. The inert rod is rotated during deposition, to form a uniform soot body 10 around the inert rod. After deposition is complete, the inert rod is preferably removed from the soot body 10, leaving a central hole 30 through a center axis 32 of the soot body 10, as shown in FIG. 5. The soot density after the OVD process is typically around 0.5 g/cm³. To increase the bulk density of the soot body 10 to the desired range, the soot body 10 is preferably partially consolidated to reach the preferred bulk density and surface density for drilling, as further described below. Alternative formation methods for forming the soot body 10 can also be used, such as a vapor axial deposition (“VAD”) process, or other known processes.

After initial formation using the soot pressing process, OVD process, VAD process, or other known processes, the soot body 10 is preferably partially consolidated to reach the predetermined bulk density of a soot blank 12 prior to drilling. Partial consolidation includes heating the soot body 10 to a temperature lower than the normal sintering peak temperature for the material used to form the soot body 10, optionally under a helium atmosphere. The exposure time and temperature will change depending on the size of the soot body 10 and on the composition or presence of any dopants in the silica-based soot material. In certain embodiments, if the soot body 10 has a density within the desired range without partial consolidation due to the method of formation of the soot body 10, then a separate partial consolidation step is unnecessary and is not required to form a soot blank 12 according to the present disclosure.

Soot bodies 10 according to the present disclosure preferably have a diameter of between 40 mm and 200 mm, with a preferred length of 10 cm to 100 cm. In general, for soot bodies 10 in this approximate size range, partial consolidation temperatures preferably range from 700° C. to 1300° C. for periods of time between 1 hour and 3 hours to create a partially consolidated soot blank 12 with porous soot material which is strengthened by the formation of glass necks between individual particles. In some embodiments, after holding the soot body 10 at the partial consolidation temperature for the predetermined time to form the soot blank 12, the soot blank 12 is held at a temperature that is elevated with respect to room temperature, but which is less than the partial consolidation temperature for a period of time to allow the soot blank 12 to further consolidate and to cool more slowly than if the soot blank 12 was returned immediately to room temperature.

The preferred bulk density of the soot blank 12 after partial consolidation is between 0.8 g/cm³ and 1.6 g/cm³. A more preferred bulk density range is from 1.0 g/cm³ to 1.6 g/cm³, and more preferred is a bulk density of between 1.2 g/cm³ and 1.5 g/cm³. Another preferred bulk density is a bulk density of 1.2 g/cm³. A preferred surface density of the soot blank 12 is less than 1.6 g/cm³, and an even more preferred surface density of the soot blank 12 is less than 1.5 g/cm³ to facilitate drilling holes 20 into the soot blank 12. The bulk density and surface densities described herein are intended to provide sufficient body and mechanical strength for drilling, while being an easier material to drill than fully consolidated glass, allowing the drilling of deeper and more precise holes 20 in the soot blank 12 than would be possible into a fully consolidated glass preform.

After forming, and optionally partially consolidating, the soot blank 12, the plurality of holes 20 are drilled in the top surface 24 of the soot blank 12 in a predetermined configuration to accommodate core canes 22, as shown in the embodiments depicted in FIGS. 3 and 6. In these embodiments four holes 20 are drilled in the top surface 24 of the soot blanks 12 to accommodate four core canes 22 for a multicore optical fiber 16 with four transmission pathways. The holes 20 drilled in the soot blanks 12 to accommodate core canes preferably have a diameter of from 5 mm to 20 mm. The drilled holes 20 preferably do not extend through the bottom surface 26 of the soot blank 12, leaving at least a small portion of the soot blank 12 in place below the holes 20 to support the core canes 22.

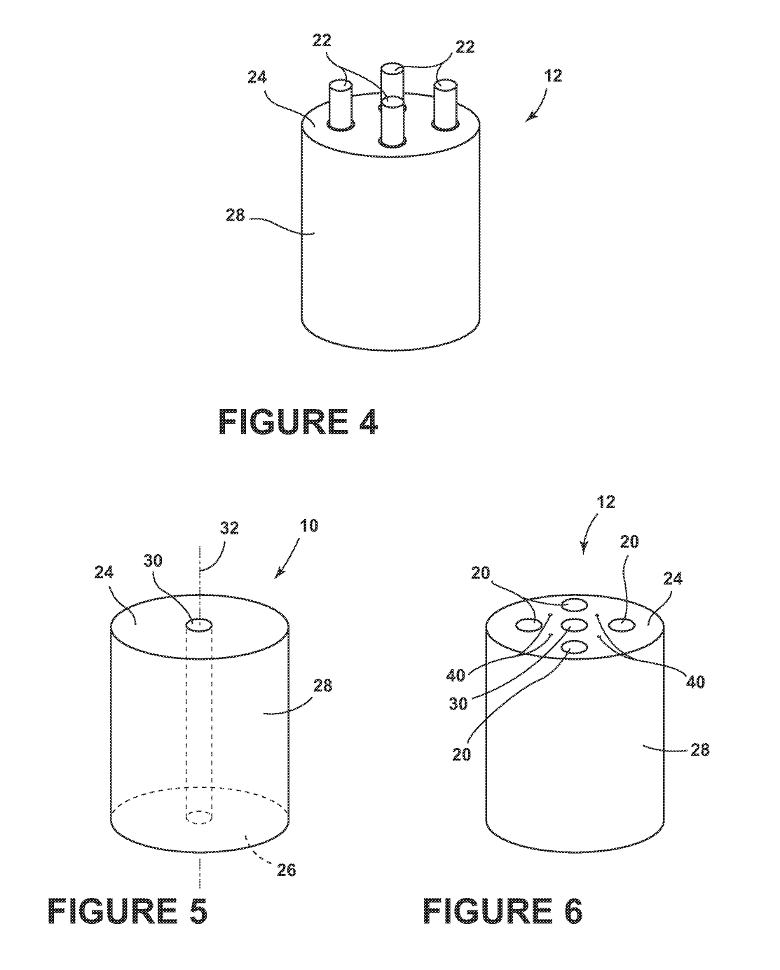

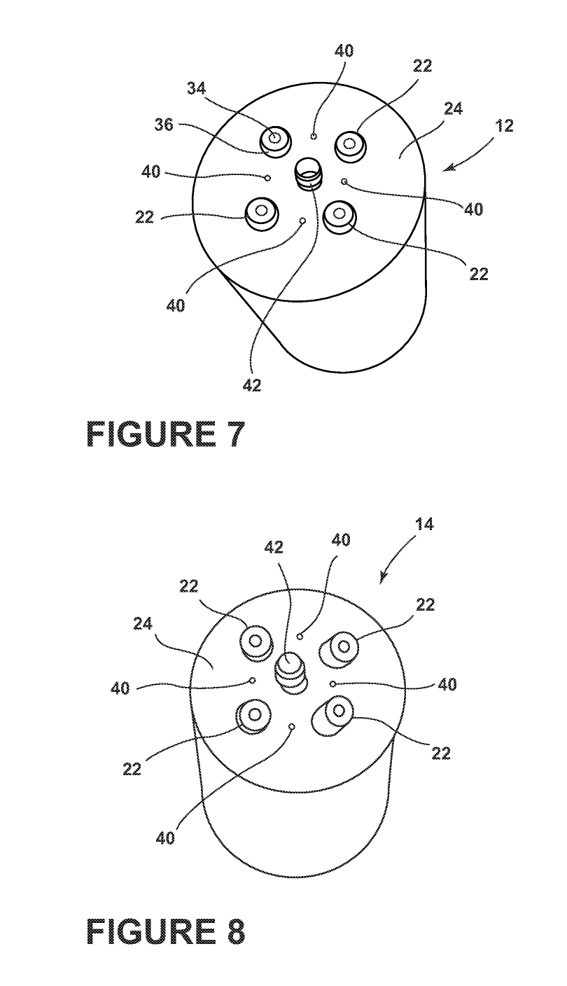

As shown in the embodiments depicted in FIGS. 4 and 7, after drilling holes 20 in the top surface 24 of the soot blank 12, core canes 22 are inserted into the drilled holes 20. Core canes 22 for use in the presently disclosed embodiments preferably have circular cross sections. The core canes 22 for use in the present disclosure are preferably made with a silica-based material, at least a portion of which is at least partially consolidated, and at least a portion of which is a transmissive core glass for an optical fiber. The core cane 22 optionally includes an inner portion 34 which is formed with a transmissive glass and an outer portion 36 which is formed with a cladding material. Germanium is commonly used as a doping agent to form transmissive glass for the core cane 22. Alternatively, the outer portion 36 of the core cane 22 can be a soot cladding material that is not consolidated. Additionally, core canes 22 for use in the present disclosure can be formed using any known processes, such as soot pressing, OVD process, VAD processes, or any other known process for forming core canes 22, whether or not fully consolidated prior to forming the preform 14. Any known alternatives for the formation of core canes 22 can be used. The core canes 22 for use in the present disclosure can be designed for multimode fiber applications, polarization maintaining fiber applications, photonic crystal fiber applications, as well as single mode multicore fiber applications and single-core fiber applications. The core canes 22 for use in the embodiments depicted in FIGS. 4 and 7 also have a diameter that is at least slightly less than the drilled holes 20, allowing insertion of the core canes 22 into the drilled holes 20 in the top surface 24 of the soot blank 12.

In addition to the holes 20 drilled to accommodate core canes 22, as shown in the embodiment depicted in FIG. 6, additional holes 40 can be drilled in the top surface 24 for the insertion of stress rods, metallic rods, conductive or shielding wires or powders, or semiconducting rods or powders. The soot blank 12 drilling method as described herein can accommodate various optical fiber designs and predetermined arrangements easily by the drilling of additional holes 40 or holes of varying sizes. The holes 20, 40 can be drilled in the top surface 24 in whatever predetermined arrangement is desired for the intended end use. The additional holes 40 can be filled before consolidation, or can be left open and filled following consolidation.

In the embodiment depicted in FIGS. 5-9, where the soot body 10 is formed via an OVD process, an additional glass rod 42 is inserted into the central hole 30. The glass rod 42 is preferably the same material as the soot material used to form the soot body 10. The glass rod 42 operates as a filler of the cladding material that makes up the soot body 10, and is generally not the same material or construction as a the core cane 22, though the central hole 30 could be used for insertion of an additional core cane 22 if desired.

The embodiment shown in FIG. 8 is a consolidated preform 14 formed from the soot blank 12 shown in FIG. 7. The embodiment shown in FIG. 8 is a consolidated glass preform 14, with a square 4-fiber configuration and a central hole 30 sealed with a glass rod 42. After inserting the core canes 22, and optionally the glass rod 42 or other stress rods, metallic rods, conductive or shielding wires or powders, or semiconducting rods or powders, the soot blank 12 and core canes 22 are consolidated to form a consolidated glass preform 14. To consolidate the soot blank 12 and the core canes 22, the soot blank 12 and the core canes 22 are heated to a final sintering temperature and held at the temperature for a time sufficient to allow glass sintering of the soot blank 12 and the core canes 22. In certain embodiments, preparatory steps such as a helium purging or chlorine drying of the soot blank 12 are carried out prior to heating the soot blank 12 to the sintering temperature. Additionally, in certain embodiments the consolidated preform 14 is held at an elevated temperature (higher than room temperature, lower than the sintering temperature) after sintering, which slows the cooling of the consolidated preform 14.

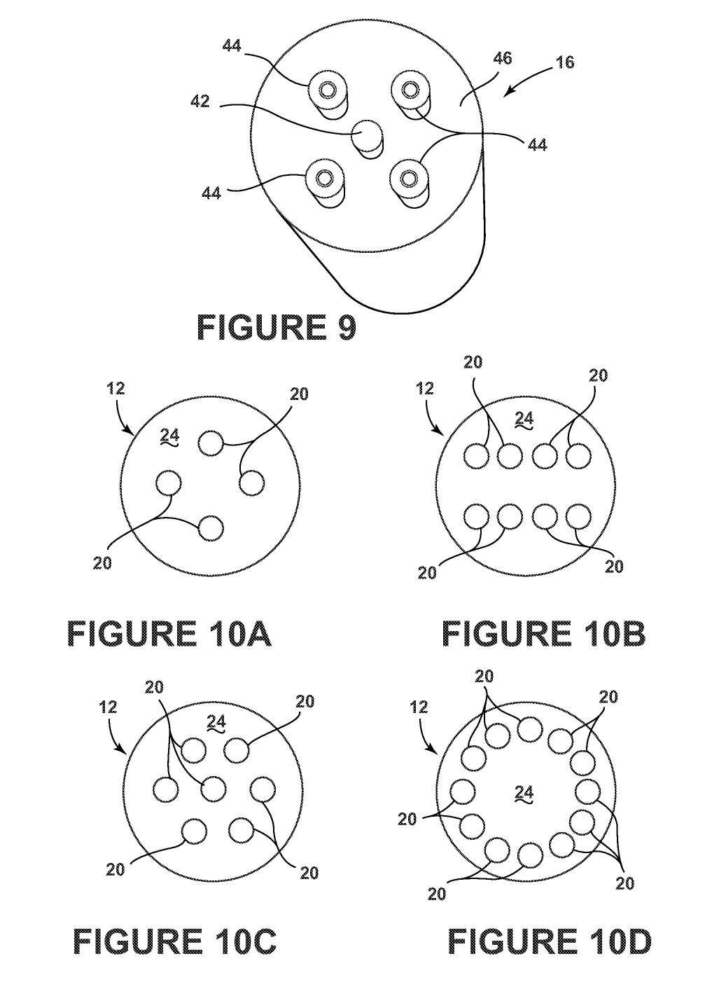

The embodiment depicted in FIG. 9 is the optical fiber 16 drawn from the preform 14 depicted in FIG. 8 using known fiber-drawing methods, such as stretching the preform 14 in a redraw furnace. The resulting optical fiber 16 is a multicore optical fiber 16 with four transmissive cores 44 embedded within an overcladding 46. The diameter of the preform 14 is reduced in the drawing process to lengthen the fiber 16, and the diameter of the core canes 22 within the preform 14 are reduced through the drawing process to form the transmissive cores 44.

Many configurations for the placement of the holes 20 in the top surface 24 of the soot blank 12 are possible when drilling the holes 20, and the configuration can be determined after production of the soot blank 12. Various sample configurations of the drilled holes 20 are shown in FIGS. 10A-10D. The examples shown in FIGS. 10A-10D are shown on a press-formed soot blank 12 (without a hole 30 from the removal of an inert rod). FIG. 10A depicts a square configuration with four drilled holes 20. FIG. 10B depicts a 2×4 configuration with eight drilled holes 20. FIG. 10C depicts a hexagonal lattice configuration with seven drilled holes 20. FIG. 10D depicts a ring configuration with twelve drilled holes 20. Alternative configurations, as desired for the formation of a chosen optical fiber 16, are easily created using the methods described herein.

In one example, 3,000 g of a SiO₂ particulate material is applied to the inert rod using an OVD process, with a post laydown density of 0.591 g/cm³. A soot body 10 having a length of 4 inches and a diameter of 63 mm was cut from the particulate material laid down using the OVD process and the inert rod was removed. The 3,000 g soot body 10 was partially consolidated by holding the soot body 10 at a temperature of 1275° C. for a period of 3 hours in a helium-based atmosphere to form a partially consolidated soot blank 12, and then holding the soot blank 12 at 950° C. for an additional period of 4 hours. After partial consolidation, the surface density of the soot blank 12 was 1.2 g/cm³, with a bulk blank density of 1.04 g/cm³. The partially consolidated soot blank 12 was drilled with four holes 20 in a square configuration, with each drilled hole 20 1 inch from the center axis 32 of the soot blank 12 and 1 inch from the other drilled holes 20. Each drilled hole 20 had an 11 mm diameter and was drilled 3.5 inches deep into the soot blank 12. One single mode fiber core cane 22 was inserted into each of the drilled holes 20, with each core cane 22 having a diameter of 10 mm. The glass rod 42 was inserted into the central hole 30 left by the removal of the inert rod to block the central hole 30. The soot blank 12, core canes 22, and glass rod 42 were placed in a sintering furnace for consolidation. The consolidation process included a 60 minute helium purge, followed by a 120 minute chlorine drying process. Once the drying was completed, an initial ramp to 1125° C. for 60 minutes was initiated. Following the initial ramp to 1125° C., the temperature of the sintering furnace was set to 1450° C. with a down feed velocity at 4.5 mm/minute for 60 minutes. After the 60 minute 1450° C. hold, the consolidated preform 14 was raised out of the hot zone of the sintering furnace and held at a temperature of 950° C. for 1 hour and then pulled from the sintering furnace and allowed to cool. The preform 14 was then stretched in a redraw furnace to a 15 mm diameter multicore optical fiber 16.

It will be apparent to those skilled in the art that various modifications and variations can be made without departing from the spirit or scope of the claims.

What is claimed is:

1. A method of forming an optical fiber, comprising the following steps:
forming a soot blank of a silica-based cladding material with the soot blank having a top surface and a bulk density of between 0.8 g/cm³ and 1.6 g/cm³;
drilling at least one hole in the top surface of the soot blank;
positioning at least one core cane member in the at least one hole;
consolidating the soot blank and the at least one soot core cane member to form a consolidated preform; and
drawing the consolidated preform into the optical fiber.

2. The method of claim 1, wherein forming a soot blank includes the steps of:
compacting a silica-based soot material into a predetermined soot body; and
partially consolidating the compacted soot body to form a soot blank with the bulk density of between 0.8 g/cm³ and 1.6 g/cm³.

3. The method of claim 2, wherein the step of partially consolidating the compacted soot body includes exposing the compacted soot material to a temperature that is less than a normal sintering temperature for the soot material.

4. The method of claim 1, wherein the step of forming a soot blank includes the steps of:
applying a silica-based soot material around at least one rod to create a soot body; and
partially consolidating the soot body to form a soot blank with a bulk density of between 0.8 g/cm³ and 1.6 g/cm³.

5. The method of claim 1, wherein the soot blank has a bulk density of from 1.0 g/cm³ to 1.5 g/cm³.

6. The method of claim 5, wherein the soot blank has a bulk density of from 1.2 g/cm³ to 1.5 g/cm³.

7. The method of claim 1, wherein the soot blank has a bulk density of 1.2 g/cm³.

8. The method of claim 1, wherein the soot blank has a diameter of from 40 mm to 200 mm, and a length of from 10 cm to 100 cm.

9. The method of claim 1, wherein the step of drilling at least one hole includes drilling the at least one hole with a diameter of from 5 mm to 20 mm.

10. The method of claim 1, wherein the step of drilling at least one hole in the top surface of the soot blank includes drilling four holes in a square pattern.

11. The method of claim 1, wherein the step of drilling at least one hole in the top surface of the soot blank includes drilling seven holes in a hexagonal lattice pattern.

12. The method of claim 1, wherein the step of drilling at least one hole in the top surface of the soot blank includes drilling 12 holes in a ring pattern.

13. A method for forming a soot blank, comprising the following steps:
forming a soot body using a silica-based soot material;
partially consolidating the soot body to form a soot blank with a top surface and a bulk density of between 0.8 g/cm³ and 1.6 g/cm³; and
drilling a plurality of holes into the top surface of the soot blank.

14. The method of forming a soot blank of claim 13, wherein the step of forming a soot body includes performing at least one process chosen from the group consisting of an outside vapor deposition process, a vapor axial deposition process, and a soot pressing process.

15. The method of forming a soot blank of claim 13, wherein the step of partially consolidating the soot body to form a soot blank includes holding the soot body at a temperature below the normal sintering peak temperature for a time sufficient to form a soot blank with a bulk density of between 1.0 g/cm³ and 1.5 g/cm³, and a surface density of less than 1.6 g/cm³.

16. The method of forming a soot blank of claim 15, wherein the soot body is held at a temperature below the normal sintering peak temperature for a time sufficient to form a soot blank with a bulk density of between 1.2 g/cm³ and 1.5 g/cm³, and a surface density of less than 1.6 g/cm³

17. The method of forming a soot blank of claim 13, wherein the step of forming the soot body includes forming the soot body using between 2,500 g and 3,500 g of the soot material.

18. The method of forming a soot blank of claim 17, wherein the step of partially consolidating the soot body includes heating the soot body to a temperature of between 700° C. and 1300° C. in a helium atmosphere.

19. A method of forming a multicore optical fiber, comprising the following steps:
forming a soot body of silica-based material;
pre-consolidating the soot body to form a soot blank with a bulk density of between 0.8 g/cm³ and 1.6 g/cm³, and a top surface with a surface density of less than 1.6 g/cm³ and a bottom surface opposite the top surface;
drilling a plurality of holes in the top surface, wherein the holes do not reach the bottom surface;
inserting a plurality of core canes into the plurality of drilled holes;
consolidating the soot blank and core canes to form a consolidated preform; and
drawing the consolidated preform into a multicore optical fiber.

20. The method of claim 19, wherein the step of consolidating the soot blank includes the steps of:
purging the soot blank under a helium atmosphere;
drying the soot blank in the presence of chlorine;
ramping the temperature around the soot blank to a first hold temperature;
increasing the temperature around the soot blank to a second sinter temperature; and
decreasing the temperature around the soot blank to a third cool down temperature.
